(19) United States
(12) Patent Application Publication
(10) Pub. No.: US 2010/0204030 A1
(43) Pub. Date: Aug. 12, 2010

(54) Collapsed Tubular Carton Erecting Apparatus & Methods

(76) Inventors: Irvan Leo Pazdernik, Alexandria, MN (US); Gene Corle, Farwell, MN (US); Glenn Stroeing, Alexandria, MN (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/670,902

(22) PCT Filed: Jun. 25, 2008
(86) PCT No.: PCT/US08/68177

§ 371 Date: Jan. 27, 2010

Related U.S. Application Data
(60) Provisional application No. 60/946,108, filed on Jun. 25, 2007.

(51) Int. Cl. B31B 5/80; B31B 5/02; B31B 5/26

(52) U.S. Cl. 493/123; 493/317; 493/136

(57) ABSTRACT

Methods and apparatus (10) for erecting cartons include a device (32) removing the upper carton (12) from a first stack of horizontally arranged cartons and pivots it to a vertical condition. The first stack is elevated by a lifting device (28) as the cartons are removed. A second stack is moved beneath the first stack when it reaches a hand-off elevation. A first connecting device (200) moves the removed carton from the vertical condition to in front of a planar plate (202) and a second connecting device (220). Suction cups (76) in a linear arrangement connect to the carton and are pivotally mounted to a pivotal transform arm (63) and move parallel to the planar plate (202). Tuckers (226, 228, 230) close the closure flaps of the carton, and a piece of tape is applied by a tape dispenser (236) thereover.

### BACKGROUND

The present invention generally relates to apparatus for erecting cartons from a collapsed condition, particularly to apparatus for erecting cartons of the tubular type from a collapsed condition, and specifically to apparatus for erecting tubular cartons which have been previously utilized or which have not been previously utilized.

Many types of products are stored and transported in cartons which hold multiple products. Once reaching their final destination, the products are removed from the carton such as for their retail sale, and the carton is disposed of. Although previously such used cartons were simply disposed of as waste, with increasing ecological and environmental awareness, such used cartons are often recycled. However, to further enhance the reduction of waste, it has become desirable for the cartons to be reused multiple times (such as on the average of eight times) before they are recycled or otherwise disposed of. It can then be appreciated that with the product removed, it is then desired that the carton be stored and transported in a flat or collapsed condition for space reduction to the factory or similar location where the carton is again erected or set up for reuse by again filling the carton with product.

Various types of packaging machines exist for erecting or setting up cartons from a blank or collapsed condition such as but not limited to U.S. Pat. No. 4,917,663. However, most existing packaging machines were designed to handle cartons which have not been previously utilized and which have not been previously erected or set up. Cartons which have been previously used and then returned to their flat or collapsed condition for reuse are not as rigid as new cartons and are more difficult to automatically, mechanically handle. Thus, many prior packaging machines had difficulty handling and erecting used cartons. This difficulty is further complicated as cartons at various stages of their lives from being new to being reused their first or second time to being reused their last time and thus of varying degrees of rigidity and ease of handling are intermixed in their collapsed condition in the carton magazine or hopper of the packaging machines.

Apparatus of the type shown in the U.S. Pat. No. 5,352,178 represented a major enhancement in the packaging field and has enjoyed market success. However, such apparatus could not be used in some applications because of the apparatus foot print required or other installation requirements. Also, there is always a continuing desire to improve the operational efficiency and functionality to better service the needs in the field of packaging machines.

Additionally, it is desired that the reuse of cartons be as competitive as possible with utilizing only new cartons in packaging in addition to the ecological advantages gained by reuse. Towards that end, it is desired that handling of the reused carton be made as minimal and as easy as possible. It can then be appreciated that collapsed cartons are typically transported back to the factory for reuse on pallets. Thus, it is desired that the collapsed cartons be easily loaded into the erecting apparatus from pallets or the like. Many prior packaging machines include carton magazines which are relatively difficult to load individual cartons from a vertical stack on a pallet.

Thus, a need continues to exist for apparatus for erecting or setting up cartons from their flat or collapsed condition which is able to handle without difficulty intermixed cartons at various stages of their lives and which allows ease and minimization of handling reused cartons from vertical stacks.

### SUMMARY

The present invention solves this need and other problems in the field of packaging machines for setting up or erecting cartons from their flat or collapsed condition by providing, in the most preferred form, novel apparatus and methods for erecting collapsed, tubular cartons.

The present invention will become clearer in light of the following detailed description of illustrative embodiments of this invention described in connection with the drawings.

### DESCRIPTION OF THE DRAWINGS

The illustrative embodiment may best be described by reference to the accompanying drawings where:

FIG. 1 shows a perspective view of an apparatus for opening or erecting cartons according to the preferred teachings of the present invention.

FIG. 2 shows a perspective view of the apparatus of FIG. 1 with portions broken away to illustrate internal components.

FIGS. 3A and 3B show perspective views of the carton removing device of the apparatus of FIG. 1.

FIG. 4 shows a perspective view of the staging magazine of the apparatus of FIG. 1.

FIGS. 5A and 5B show a perspective view of the vertically movable, carton connecting device of the apparatus of FIG. 1.

FIGS. 6A and 6B show perspective views of the stage assembly of the apparatus of FIG. 1.

FIGS. 7A-7D show perspective views of the carton opening assembly of the apparatus of FIG. 1.

FIGS. 8A-8C show perspective views of the flap folding assembly of an alternate embodiment of the apparatus of FIG. 1.

FIGS. 9A-9C show perspective views of the tape dispenser of the apparatus of FIGS. 8A-8C.

FIGS. 10A-10C show perspective views of a chute assembly of the apparatus of FIG. 1.

All figures are drawn for ease of explanation of the basic teachings of the present invention only; the extensions of the figures with respect to number, position, relationship and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the term “top”, “bottom”, “first”, “second”, “inside”, “outside”, “front”, “back”, “rear”, “upper”, “lower”, “height”, “width”, “end”, “side”, “horizontal”, “vertical”, and similar terms are used herein, it should be understood that these terms have reference only to the structure shown in the drawings as it would appear to a person viewing the drawings and are utilized only to facilitate describing the invention.

### DESCRIPTION

Apparatus for opening or erecting cartons according to the preferred teachings of the present invention is shown in the drawings and generally designated 10. Although apparatus 10 and the carton erecting methods performed thereby may be utilized with cartons of various configurations, apparatus 10 is designed primarily for opening cartons 12 of the type illustrated in the drawings. Such cartons 12 generally comprise a plurality of body walls, such as side panels 14 and 16 and end panels 18 and 20 which are hingedly connected together about hinge axes along hinge connections into an annularly continuous tubular configuration in any suitable manner. Such body walls may have any suitable dimensional relationship, but in the embodiment illustrated, side panels 14 and 16 are of a width somewhat greater than the width of end panels 18 and 20. All of such walls have equal length, however. In the horizontally arranged, collapsed condition, panels 14 and 20 are vertically below, underlie, and are in contact with the inner surfaces of panels 16 and 18.

Hingedly connected to carton 12 at opposite ends thereof are carton closure means in the form of opposite cooperable pairs of closure flaps 22-25 which are intended to seal the top and bottom of carton 12. Corresponding flaps 22-25 at opposite ends of carton 12 generally are identical. Particularly, hingedly connected to the margin of each of side panels 14 and 16 are upper and lower major closure flaps 22 and 23, respectively. A pair of minor end closure side flaps 24 and 25 are hingedly connected to margins of opposite end panels 18 and 20, respectively. When carton 12 is collapsed, major flaps 23 and upper minor flaps 24 are vertically above, overlie and contact the inner faces of lower major flaps 22 and lower minor flaps 25.

Minor flaps 24 and 25 are of substantially less width than major flaps 22 and 23 so that the outer free edges of flaps 22 and 23 extend longitudinally of carton 12 beyond the outer free edges of minor flaps 24 and 25.

Apparatus 10 of the present invention is designed to transform cartons 12 from the collapsed tubular state to the open ended erected tubular state shown. Apparatus 10 may take various forms but the illustrated embodiment includes a collapsed carton supply hopper 26 of any suitable design in which a supply of collapsed cartons 12 is positioned. In the preferred form, hopper 26 is vertically arranged with collapsed cartons 12 stacked upon a device 28 for raising or vertically lifting the stack of collapsed cartons 12. For example, device 28 in the preferred form is a lift fork which is electrically controlled by a trigger. Thus, when the top carton 12 is removed from the top of the stack of cartons 12 supported upon lifting device 28 and from under the trigger, device 28 is actuated to raise the stack of collapsed cartons 12 until the next carton 12 (then the top) of the stack of cartons 12 engages with the trigger which stops further actuation of lifting device 28.

Apparatus 10 further includes a device 32 for removing the upper carton 12 from the top of the stack of cartons 12 in hopper 26, pivoting it 90° and placing it at a vertical position adjacent to hopper 26. In the most preferred form, a horizontal shaft 34 is rotatably mounted extending parallel to and spaced from the free edges of flaps 22-25 and spaced slightly above the top carton 12 in hopper 26. Shaft 34 is pivoted through a range of approximately 90° by any suitable means such as by a gear drive 36 driven by a servo motor 38. Device 32 further includes first and second arms 42 secured to and extending generally perpendicular from shaft 34, with the first and second arms 42 located on opposite sides of hopper 26. Rotation of shaft 34 causes the pivotal movement of arms 42 to move in a quarter-circle arc about shaft 34 between a horizontal, removal position located above and parallel to cartons 12 in hopper 26 and a vertical, hand-off position generally horizontally offset from the removal position. A shaft 44 is pivotally mounted to and between the free ends of arms 42 spaced from and parallel to shaft 34. A plurality of support arms 52-54 are secured generally perpendicular to shaft 44 and in a spaced parallel relation. A plurality of suction cups 56 are secured to each of arms 52-54 and attach to panels 16 and 18 and flaps 23 and 24.

Support arms 52-54 are pivoted about the axis defined by shaft 44 to extend generally in line with arms 42 and to engage and secure to the top carton in hopper 26 where arms 42 are in the horizontal, removal position. While anus 42 pivot from the removal position to the hand-off position, support arms 52-54 pivot about the pivot axis defined by shaft 44 inwardly to hold the carton vertically and on the opposite side of support arms 52-54 than hopper 26.

In the preferred form shown, apparatus 10 further includes a staging magazine 260 including a fork 280 slideable from a home position inside magazine 260 to an extended position inside of hopper 26. Magazine 260 further includes a plurality of conveyers 320 extending from the bottom of magazine 260 into the bottom of hopper 26 for moving cartons in a conveying direction, with the device 28 being moveable perpendicular to the conveying direction. In the most preferred form, the tines of the lift fork forming device 28 are positionable between conveyors 320 in its lowermost position and have an extent in the conveying direction less than conveyors 320 and extend below the first stack of cartons in the initial position but not below the second stack of cartons. Magazine 260 further includes movable guides 340 in the form of parallelograms extending perpendicular to the movement direction of fork 280 and conveyors 320.

In operation, first and second stacks of collapsed cartons arranged horizontally are loaded into magazine 260 on top of conveyors 320 below fork 280, with the second stack of cartons engaging guides 340 in their closed position. When device 28 is raised to an elevated, hand-off position and the first stack of cartons is almost depleted in hopper 26 (which could be sensed by a suitable sensor), fork 280 is moved from its home position above the second stack of cartons to its extended position below the first stack of cartons in hopper 26. It should be appreciated that the tines of fork 280 should not engage and are located between the tines of the lift fork forming device 28. Further, it should be appreciated that device 28 can be raised slightly before fork 280 moves if desired. After fork 280 is in the extended position, device 28 can be lowered past fork 280 (such that the cartons are supported upon fork 280) to its lowermost position coextensive with conveyors 320. At that time, guides 340 can be opened and conveyors 320 activated to transport the second stack of cartons from magazine 260 into hopper 26 above device 28 and beneath the first stack of cartons. At that time, guides 340 are moved to their closed position. It should be appreciated that operation of apparatus 10 continues while the second stack of cartons 12 are conveyed into hopper 26 and with device 32 removing cartons 12 from the first stack of cartons on the top of fork 280. After the last carton 12 has been removed from fork 280 and fork 280 is returned to its home position in magazine 260, device 32 then begins to remove cartons 12 from the second stack of cartons that have been positioned on and raised to contact the trigger by device 28 and which becomes the first stack of collapsed cartons in continued operation.

When arms 42 are in the hand-off position and the carton is held vertically by device 32, the carton engages a carton connecting device 200 in an upper position. In the preferred form shown, the carton connecting device 200 includes a plurality of suction cups. When device 200 engages the carton, the carton is connected to device 200 (such as by connection to a vacuum source) and is released from suction cups 56 (such as by disconnecting from a vacuum source). Device 32 can return to its initial position for the next cycle.

With carton connected thereto, carton connecting device 200 is moved from its upper position to a downward position where the carton is positioned in front of a vertical plate 202. Device 200 in its upper position is spaced vertically above the vertical plate 202. Device 200 can be movably supported in any desired manner. In the form shown, device 200 is connected to a linear bearing 204 and is moved by securement to a belt 206 which can be driven by a servomotor 208. Vacuum can be supplied through a flexible carrier 210 to device 200. It should be appreciated that vertical plate 202 can be formed as a single component with suitable cut outs or can be formed as a plurality of spaced components to allow device 200 and the components carried nearby to be in a non-interfering relation.

Vertical plate 202 is carried by a stage 212. A second connecting device 220 such as in the form of suction cups is also carried by stage 212 and in a non-interfering relation with device 200 and plate 202. Connecting device 220 connects to panel 14 of carton 12.

Connecting device 220 is horizontally moveable between an outer position and an inner position such as by linear bearings 214 and an air cylinder 216. In operation, connecting device 220 is in its outer position when device 200 is moved to its downward position, with the carton in front of vertical plate 202. Device 220 is connected to the carton (such as by connection to a source of vacuum) and device 200 is disconnected from the cartons (such as by disconnecting from a source of vacuum). Thereafter, connecting device 220 is moved to its inner position to space the carton and plate 202 from device 200.

Apparatus 10 further includes a movable, vertical, planar plate 60 movable from an attachment position to an open position. Suction cups 76 in a single linear arrangement are mounted below plate 60. Plate 60 and suction cups 76 have a size corresponding to panel 16, with suction cups 76 located on panel 16 adjacent and parallel to the hinge connection with flap 23. When the carton is moved to the downward position by carton connecting device 200, the carton is intermediate vertical plate 202 and suction cups 76.

Plate 60 and suction cups 76 are movable between the attachment position and the open position in the most preferred form by being pivotally mounted about a vertical arm axis to a free end of a transform arm 63 having its opposite end pivotably mounted to the frame about a spaced, parallel, vertical arm axis. It should be appreciated that the arm axes of arm 63 are spaced from and parallel to the vertical hinge axes of the carton 12. Furthermore, the single linear arrangement of the suction cups 76 are perpendicular to the arm axes of arm 63 and to the hinge axes of the carton 12 and parallel to the vertical plate 202. The plate 60 and suction cups 76 are maintained in a parallel relation to plate 202 as well as moved between the attached position and the open position such as by an air cylinder 65 connected to a multiple arm pivot assembly 67 as shown. It should be appreciated that maintaining plate 60 in a parallel relation can be accomplished in other manners including, but not limited to, a servo—gear box—belt—pulley combination attached to the shaft on arm 63 defining the first arm axis.

Plate 60 and suction cups 76 can be moved to its open position located horizontally offset, parallel to and coinciding with panel 14 and spaced therefrom generally equal to the width of panels 18 and 20. Due to the attachment of suction cups 76 to panel 16, movement of plate 60 and suction cups 76 to its open position causes carton 12 to also open with panels 18 and 20 pivoting about their hinge connections to panels 14 and 16 in a parallelogram movement corresponding to the parallelogram movement of plate 60 and suction cups 76. As panel 14 is attached to connecting device 220 and panel 16 is attached to suction cups 76, a vertical, parallel relationship is maintained between panels 14 and 16 during movement of plate 60 from the attachment position to the open position.

It should then be appreciated that panel 14 is firmly supported by a connecting device to maintain a planar configuration. Likewise, panel 16 is supported by and attached by suction cups 76 to maintain a planar configuration (with suction cups 76 located adjacent to and parallel the hinge connection with flap 23). Additionally, panels 18 and 20 maintain their planar configuration due to their parallelogram movement relative to panels 14 and 16. Thus, apparatus 10 is able to open cartons 12 from a collapsed condition of various degrees of rigidity from being not previously opened to being opened and collapsed a multiple number of times, and with cartons 12 of intermixed degrees of rigidity without handling difficulties.

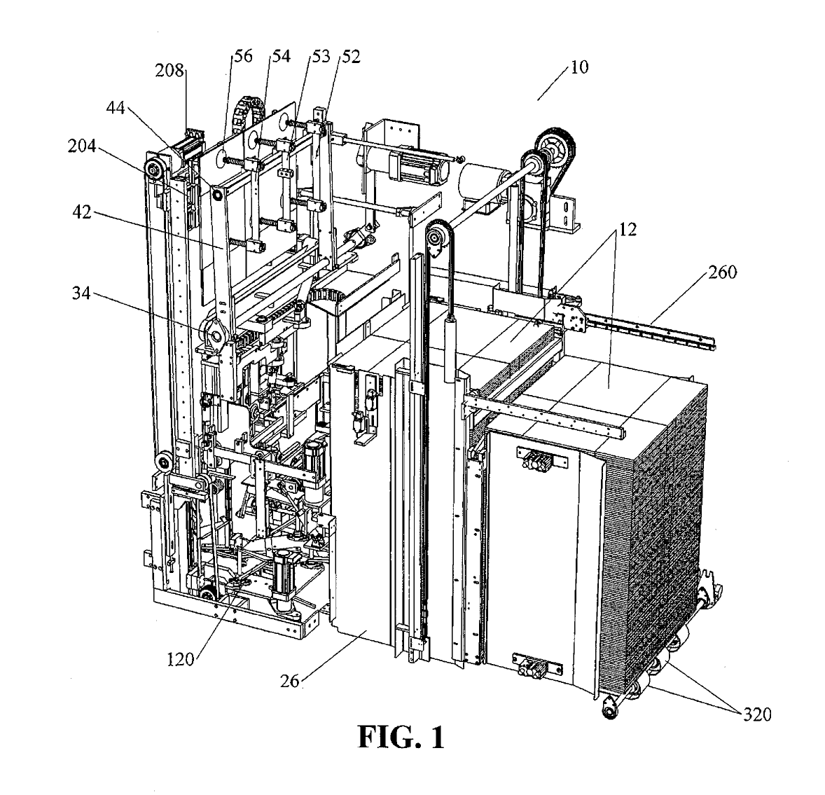

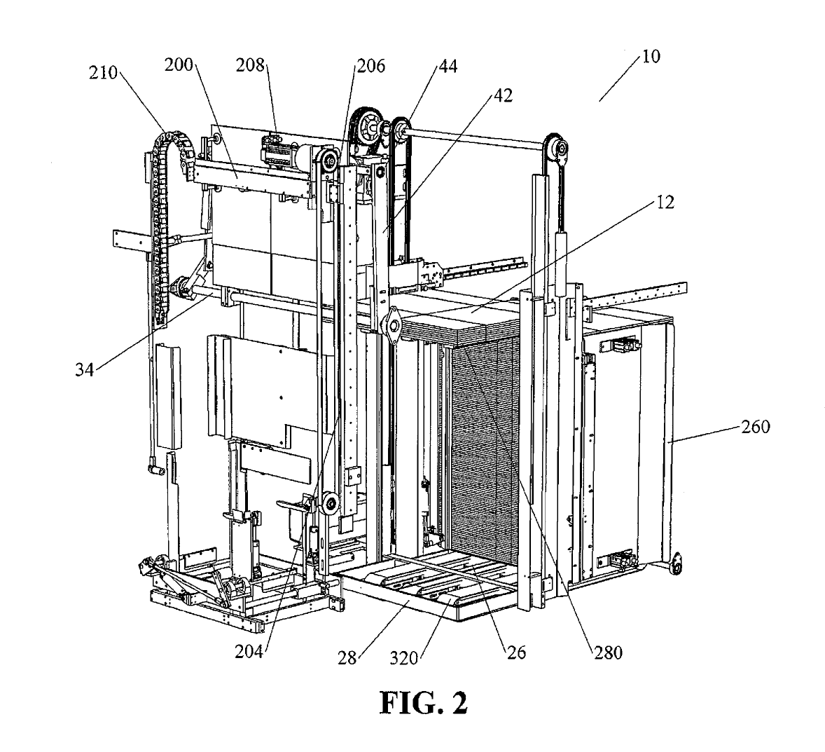

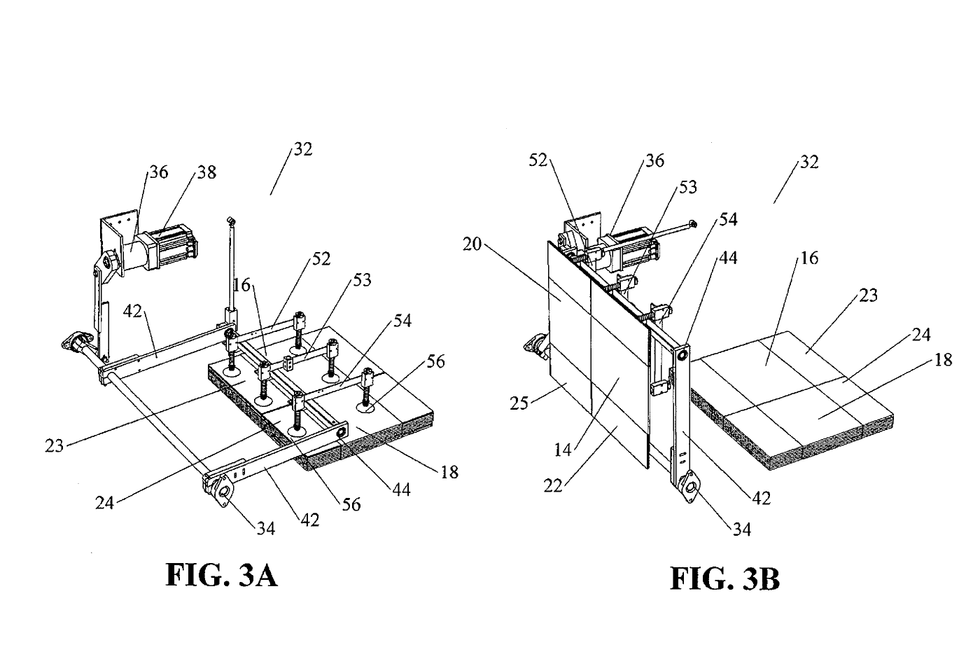

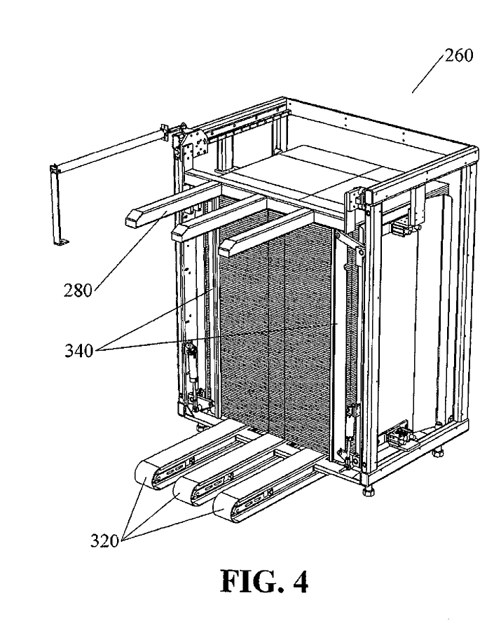

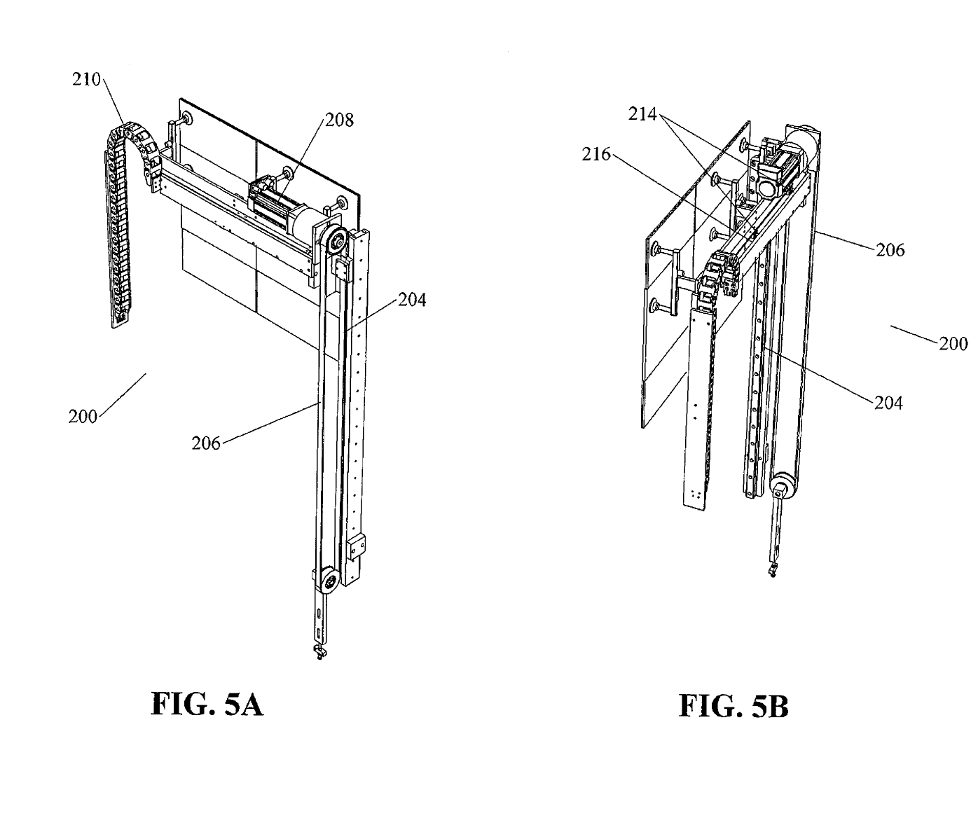

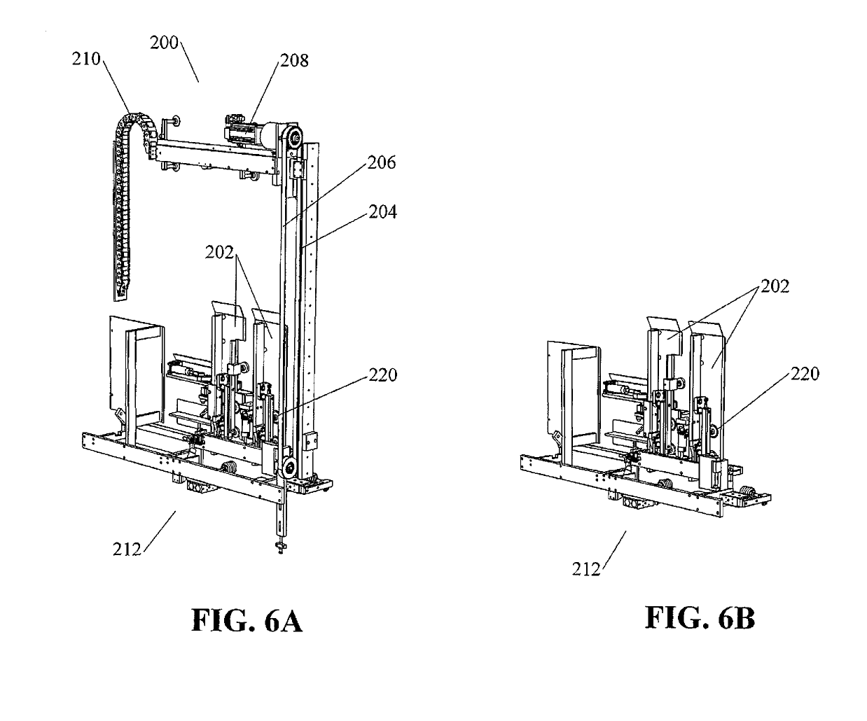

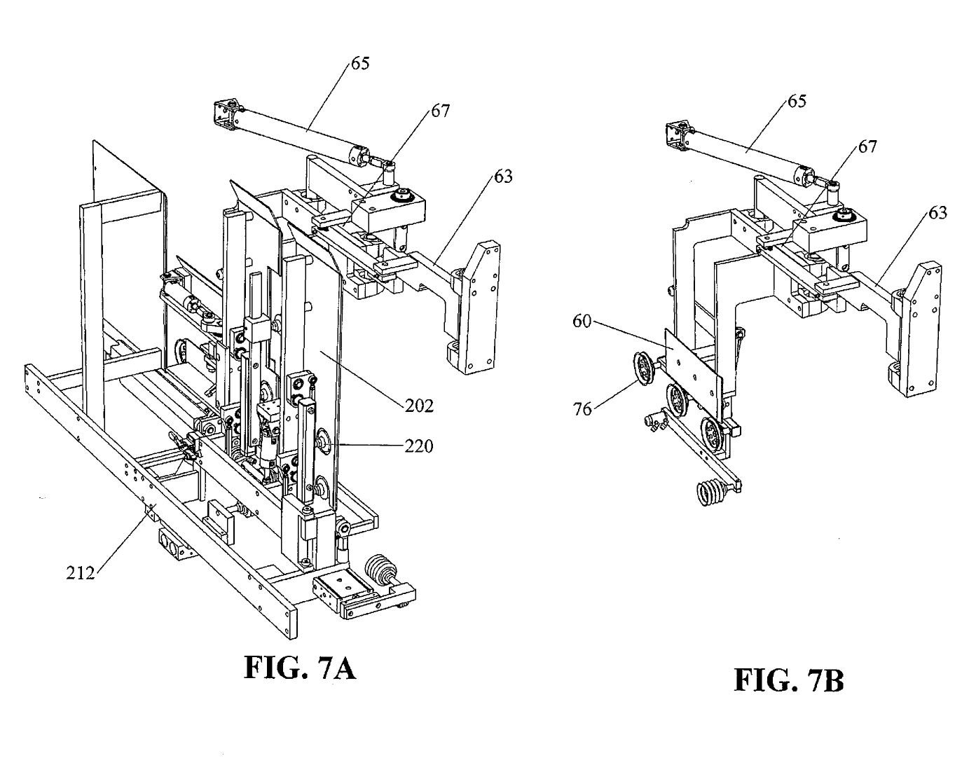

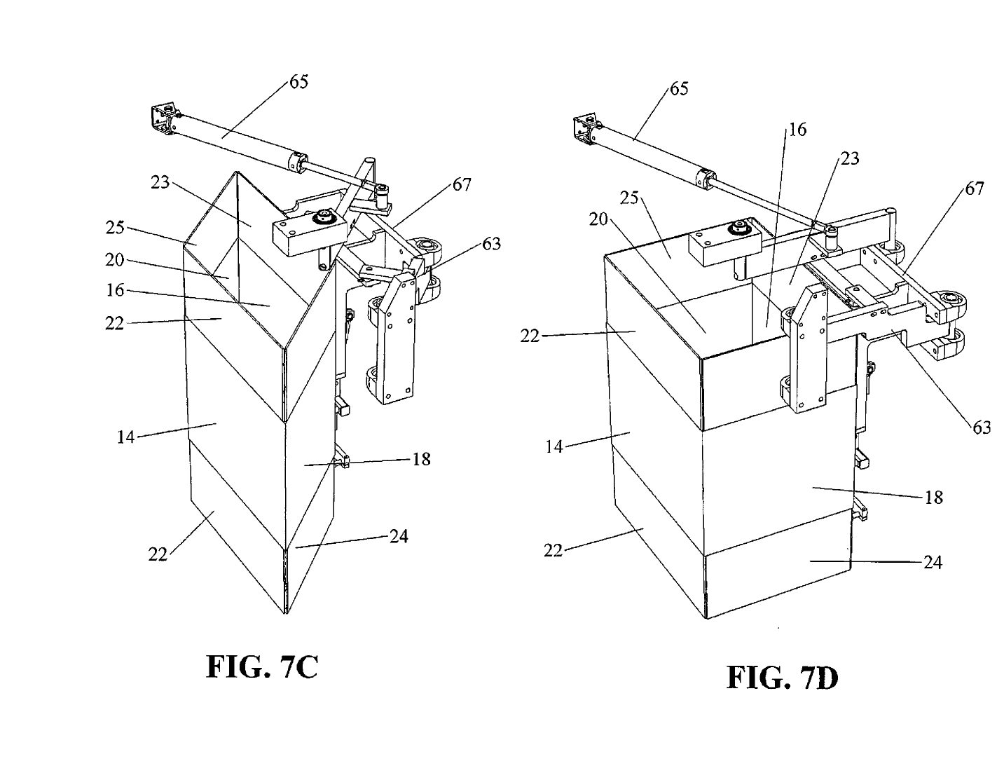

In the preferred form of the present invention shown in FIG. 1, a device 120 is provided for fan folding flaps 22-25 so that tape is not required to seal the bottom of carton 12. The construction and operation of device 120 is shown and described in U.S. Pat. No. 5,352,178, which is hereby incorporated by reference herein. The major distinction is the orientation of the carton 12 and device 120 of apparatus 10 herein versus that shown in U.S. Pat. No. 5,352,178.

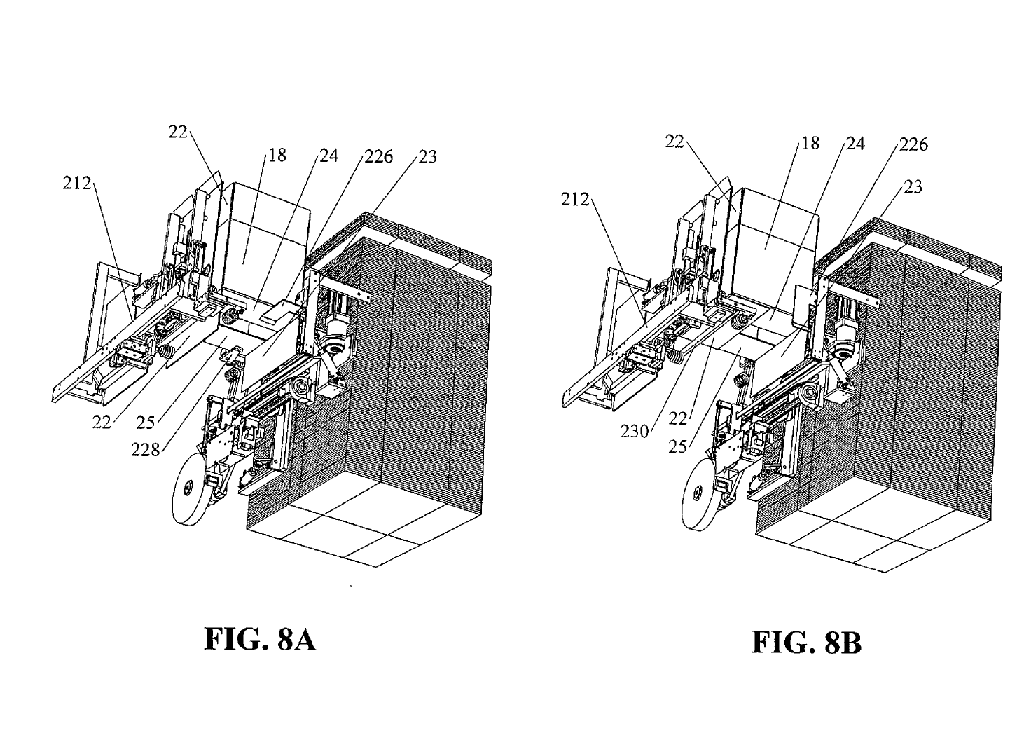

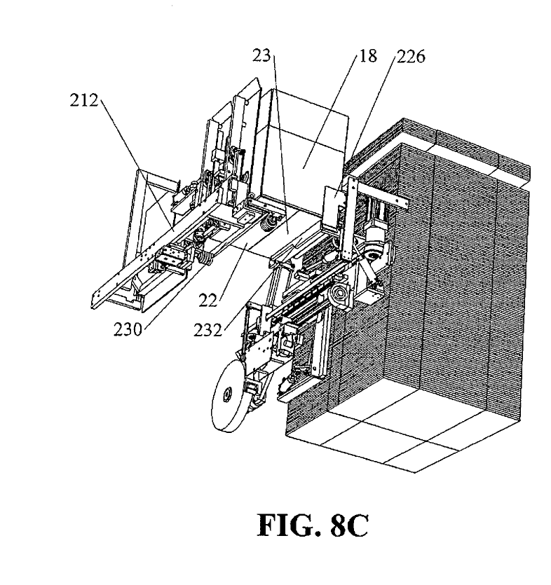

In another preferred form of the present invention, minor flaps 24 and 25 are folded inward by pivotal tuckers 226 and 228, respectively, pivotally mounted about horizontal axes perpendicular to the arm axes and the hinge axes as best seen in FIG. 8A. A tucker bar 230 is pivoted inwardly to fold flap 22, and, then, tuckers 226 and 228 are pivoted back to their normal position. Thereafter, a tucker bar 232 is pivoted inwardly to fold flap 23. It should be appreciated that carton 12 is supported on tucker bars 230 and 232 arranged in a spaced, parallel relation.

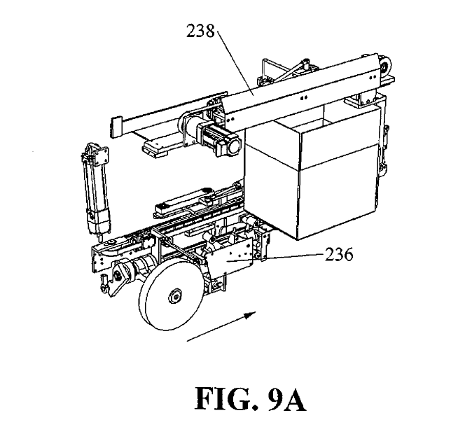

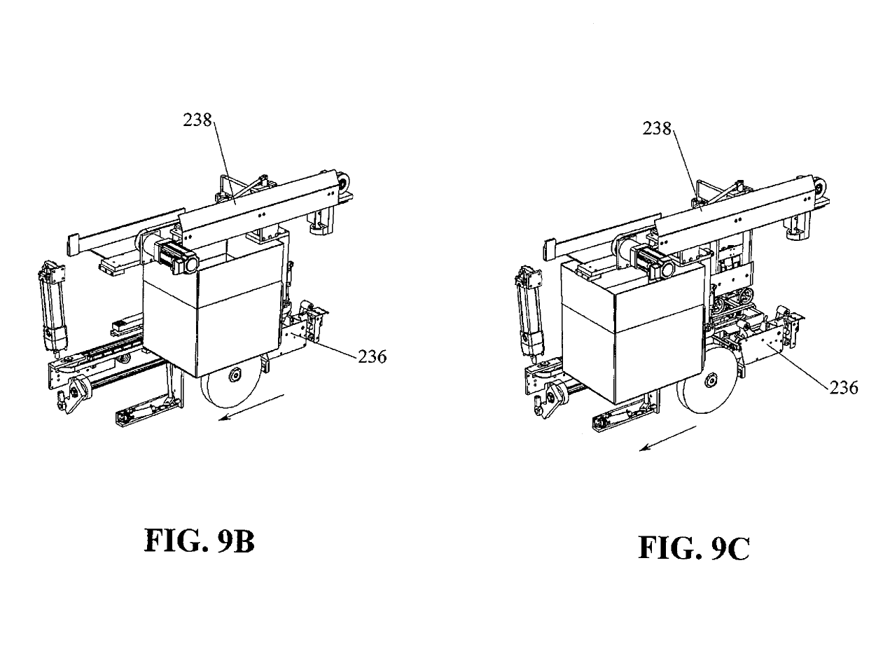

A tape dispenser 236 is moved in an application direction to apply a piece of tape extending between at least flaps 22 and 23 supported upon tucker bars 230 and 232 as shown in FIG. 9A. In the preferred form, tape dispenser 236 is only moved partially between panels 18 and 20, and then, carton 12 is moved opposite to the application direction relative to the tape dispenser 236 by a pushing mechanism 238 as shown in FIG. 9B. Thus, the tape piece extends completely between panels 18 and 20.

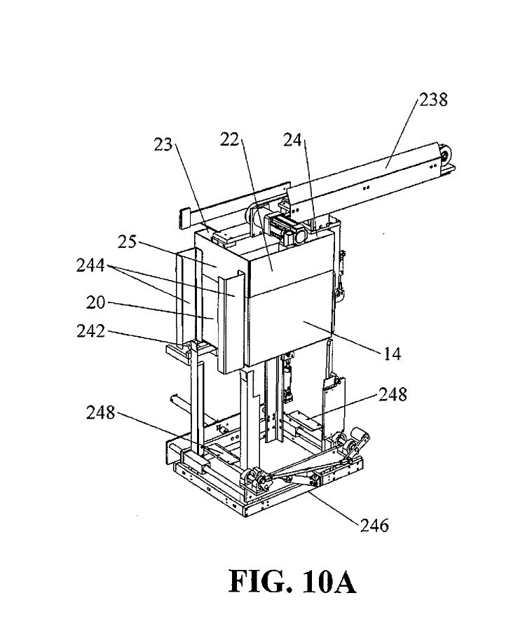

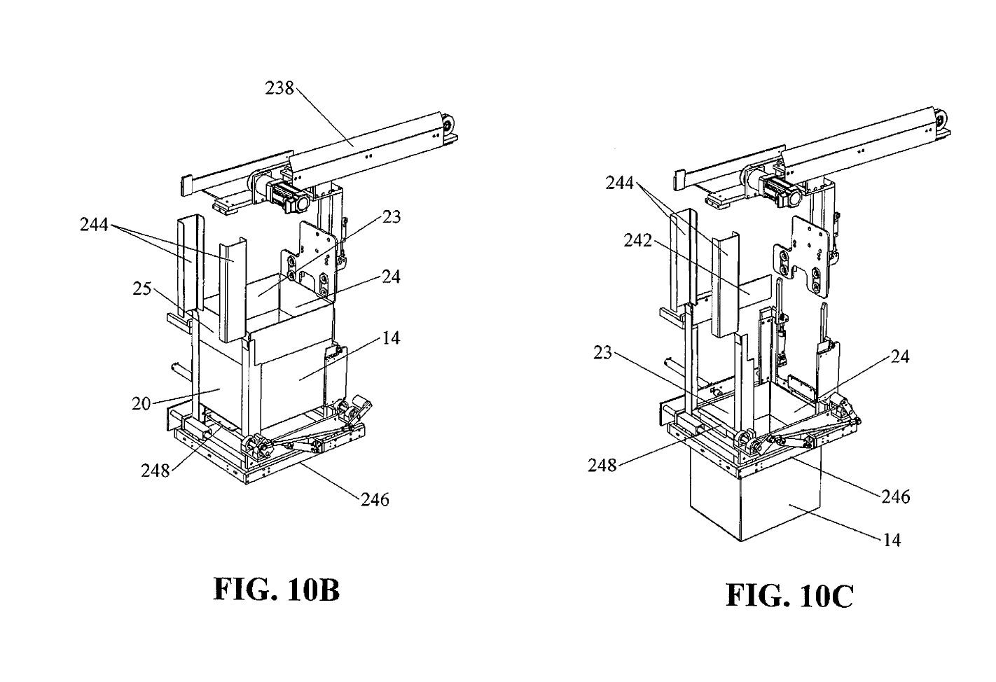

After the tape piece has been cut from the continuous source of tape, carton 12 is continued to be pushed by mechanism 238 beyond tape mechanism 230 as shown in FIGS. 9C and 10A onto a pivotal horizontal stand 242 in a horizontal position, with one shown in FIG. 10C and against spaced, parallel, vertical stops 244 shown in FIGS. 10A, 10B and 10C. In the most preferred form, apparatus 10 includes a sensor to check that bottom flaps 22-25 do not extend beyond the bottom of panel 14, 16, 18 and 20 (which typically indicates that flaps 22-25 are not properly fan folded in the apparatus of FIG. 1 or not appropriately sealed by tape dispenser 236 of FIGS. 9A-9C. Assuming no downwardly extending flaps 22-25 are detected, stand 242 is pivoted from its horizontal position so that carton 12 falls under gravitational forces down a chute 246 having pivotal, horizontal stands 248 pivotal about axes perpendicular to the pivot axis of stand 242. In similar manner, stands 248 can pivot so that carton 12 falls under gravitational forces from chute 246 for further processing as desired.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method comprising: holding a first side panel of a carton including a first end panel hingedly connected about a first vertical axis to the first side panel and hingedly connected about a second vertical axis spaced from and parallel to the first vertical axis to a second side panel, with the carton being collapsed, with the first side panel abutting with the first end panel and the second side panel; securing the second side panel with suction cups in an attachment position and in a single linear arrangement perpendicular to the first and second vertical axes; and moving the suction cups with the single linear arrangement and the second side panel being parallel to the first side panel to an open position when the first end panel is perpendicular to the first and second side panels.

2. The method of claim 1 wherein moving the suction cups comprises pivotally mounting the suction cups to an end of a transform arm about a first arm axis spaced from and parallel to the first and second vertical axes; and pivoting the transform arm about a second arm axis spaced from and parallel to the first arm axis.

3. The method of claim 1 further comprising abutting the second side panel with a planar plate while the suction cups are secured to the second side panel, with the suction cups being vertically below the planar plate.

4. The method of claim 1 wherein holding the first side panel comprises abutting the first side panel with a vertical plate and with a first connecting device, with moving the suction cups comprising moving the suction cups with the single linear arrangement parallel to the vertical plate.

5. The method of claim 4 further comprising moving the collapsed carton from an upper position spaced vertically above the vertical plate vertically downward to a downward position in front of the vertical plate and intermediate the vertical plate and the suction cups; and moving the first connecting device from an outer position spaced outwardly from the collapsed carton to an inner position moving the collapsed carton towards the suction cups.

6. The method of claim 5 further comprising removing an upper collapsed carton from a magazine holding a first stack of collapsed cartons arranged horizontally; and pivoting the removed, upper collapsed carton 90° to the upper position.

7. The method of claim 6 further comprising elevating the first stack of cartons after the upper collapsed carton is removed from the first stack until the first stack reaches a hand-off elevation; holding the first stack of collapsed cartons at the hand-off elevation and conveying a second stack of the cartons beneath the first stack of collapsed cartons held at the hand-off elevation with the second stack of collapsed cartons becoming the first stack of collapsed cartons after a lowest collapsed carton is removed from the first stack of collapsed cartons.

8. The method of claim 7 wherein conveying the second stack of collapsed cartons comprises loading the first and second stacks of collapsed cartons on a plurality of spaced, parallel conveyors; wherein elevating the first stack of collapsed cartons comprises raising a lift fork having tines from an initial position intermediate the plurality of spaced, parallel conveyors and extending beneath the first stack of collapsed cartons and not beneath the second stack of collapsed cartons; with holding the first stack of collapsed cartons comprising moving a holding fork from a home position above the second stack of collapsed cartons to an extended position below the first stack of collapsed cartons, and lowering the lift fork past the holding fork in the extended position and to the initial position, with conveying the second stack of collapsed cartons occurring after the lift fork is lowered into the initial position.

9. The method of claim 1 further comprising moving tuckers to fold closure flaps hingedly connected to the first and second end panels and the first side panel about horizontal axes to extend generally perpendicularly to the first and second end panels and the first side panel; moving a tape dispenser in an application direction to apply tape to the closure flaps of the first and second end panels while on the tuckers; and pushing the carton opposite to the application direction past the tape dispenser while on the tuckers.

10. The method of claim 9 wherein pushing the carton comprises pushing the carton beyond the tape dispenser and unto at least one stand in a horizontal position; and pivoting the stand from the horizontal position after the carton is pushed thereon, with the carton falling down a chute after the stand pivots from the horizontal position.

11. Method comprising: loading first and second stacks of collapsed cartons; removing an upper collapsed carton of the first stack of collapsed cartons and elevating the first stack of collapsed cartons to a hand-off elevation at a hand-off elevation above the second stack of collapsed cartons; holding the first stack of collapsed cartons at the hand-off elevation and conveying the second stack of collapsed cartons beneath the first stack of collapsed cartons held at the hand-off elevation; and removing an upper carton of the conveyed second stack of collapsed cartons after the last collapsed carton of the first stack of collapsed cartons has been removed.

12. The method of claim 11 wherein loading the first and second stacks of collapsed cartons comprises loading the first and second stacks of collapsed cartons on a plurality of spaced, parallel conveyors; wherein elevating the first stack of collapsed cartons comprises raising a lift fork having tines from an initial position intermediate the plurality of spaced, parallel conveyors and extending beneath the first stack of collapsed cartons and not beneath the second stack of collapsed cartons; with holding the first stack of collapsed cartons comprising moving a holding fork from a home position above the second stack of collapsed cartons to an extended position below the first stack of collapsed cartons, and lowering the lift fork past the holding fork in the extended position and to the initial position, with conveying the second stack of collapsed cartons occurring after the lift fork is lowered into the initial position.

13. The method of claim 11 further comprising providing guides in a closed position between the first and second stacks of collapsed cartons before the first stack of collapsed cartons are held; and moving the guides in an open position for guiding the second stack of collapsed cartons while the second stack of collapsed cartons is being conveyed.

14. Magazine comprising, in combination: a plurality of spaced, parallel conveyors for movement in a conveying direction and for receiving first and second stacks of collapsed cartons; a lift fork having tines intermediate the plurality of spaced, parallel conveyors in an initial position, with the lift fork moveable perpendicular to the conveying direction from the initial position to an elevated position, with the tines of the fork having an extent in the conveying direction less than the plurality of spaced, parallel conveyors and extending in the initial position below the first stack of collapsed cartons and not below the second stack of collapsed cartons; and a holding fork moveable parallel to the conveying direction from a home position above the second stack of collapsed cartons to an extended position at the elevated position below the first stack of collapsed cartons.

15. The magazine of claim 14 further comprising, in combination: guides movable between a closed position extending perpendicular to the conveying direction and abutting with the first stack of collapsed cartons and intermediate the first and second stacks of collapsed cartons and an open position extending parallel to the conveying direction.

16. Apparatus for transforming cartons having a first side panel and a first end panel hingedly connected about a first vertical axis to the first side panel and hingedly connected about a second vertical axis spaced from and parallel to the first vertical axis to a second side panel, with the carton being collapsed, with the first side panel abutting with the first end panel and the second side panel, with the apparatus comprising, in combination: a plurality of suction cups in a single linear arrangement; a transform arm, with the plurality of suction cups pivotally mounted about a first arm axis perpendicular to the single linear arrangement, with the transform arm pivotally mounted about a second arm axis spaced from and parallel to the first arm axis; a first connecting device connecting to the first side panel, with the suction cups connecting to the second side panel, with the plurality of suction cups pivoting relative to the transform arm as the transform arm pivots to maintain the suction cups parallel to the first connecting device.

17. The apparatus of claim 16 further comprising, in combination: a vertical plate, with the vertical plate and the first connecting device carried by a stage, with the vertical plate abutting with the first side panel when the first connecting device is connected to the first side panel; and a planar plate pivotally mounted to the transform arm about the first arm axis, with the first arm axis being parallel to the planar plate, with the planar plate abutting with the second side panel of the carton when the plurality of suction cups are connected to the second side panel.

18. The apparatus of claim 17 further comprising, in combination: a second connecting device movable between an upper position and a lower position parallel to the first and second arm axes, with the stage movable between an outer position to an inner position perpendicular to the first and second arm axes, with the inner position located intermediate the outer position and the planar plate, with the second connection device removably connectable to the first side panel, with the first connecting device being in the outer position when the second connecting device is moved into its lower position, with the connection of the first side panel to the second connection device being removed when the stage is in its inner position.

19. The apparatus of claim 18 further comprising, in combination: a device for removing an upper carton from a first stack of collapsed cartons held in a magazine comprising a shaft movable along an arc generally 90°; a plurality of support arms extending radially from the shaft, with the shaft and the plurality of support arms movable to a removed position extending perpendicular to the first and second arm axes, and a hand-off position extending parallel to the first and second arm axes, with the support arms connectable to the second side panel of the collapsed carton, with the second connecting device connectable to the first side panel of the collapsed carton in the upper position when the plurality of support arms are in the hand-off position.

20. The apparatus of claim 18 wherein the magazine comprises in combination: a plurality of spaced, parallel conveyors for movement in a conveying direction and for receiving first and second stacks of collapsed cartons; a lift fork having tines intermediate the plurality of spaced, parallel conveyors in an initial position, with the lift fork moveable perpendicular to the conveying direction from the initial position to an elevated position, with the tines of the fork having an extent in the conveying direction less than the plurality of spaced, parallel conveyors and extending in the initial position below the first stack of collapsed cartons and not below the second stack of collapsed cartons; and a holding fork moveable parallel to the conveying direction from a home position above the second stack of collapsed cartons to an extended position at the elevated position below the first stack of collapsed cartons.
